(19) United States
(12) Patent Application Publication
(10) Pub. No.: US 2024/0116211 A1
(43) Pub. Date: Apr. 11, 2024

(54) FIBER DISTRIBUTION DEVICE AND SYSTEM THEREWITH AND METHOD THEREFOR

(71) Applicant: Roess Nature Group GmbH & Co. KG, Twistringen (DE)

(72) Inventors: Thomas Roess, Twistringen (DE); Kai Siewert, Bassum (DE)

(21) Appl. No.: 18/484,060

(22) Filed: Oct. 10, 2023

(30) Foreign Application Priority Data
Oct. 11, 2022 (DE) 10 2022 126 273.1

(51) Int. Cl. B27N 3/12; B27N 3/04

(52) U.S. Cl. CPC B27N 3/12; B27N 3/04

(57) ABSTRACT

A fiber distribution device to provide fiber material, such as straw fibers, coconut fibers, wood fibers or hemp fibers for a compacting device comprises a distributor box, wherein the distributor box has an interior with a connecting opening on the upper side and with a delivery opening on the underside for delivering the fiber material, and a distribution arrangement with a distribution arrangement housing, which has a connecting opening on the underside for connecting to the connecting opening of the distributor box on the upper side, and an inlet opening for feeding the fiber material. The distribution arrangement has a tube portion for feeding the fiber material from an exterior of the distribution arrangement into the interior of the distributor box or into the distribution arrangement housing, wherein the tube portion has a stationary part for connecting to a feed line guiding the fiber material, and a movable part for delivering the fiber material, and a motor, which is connected to the movable part and is arranged to move the movable part in the distribution arrangement and/or in the interior of the distributor box. A system comprises a fiber distribution device and a method for providing fiber material for a compacting device with a fiber distribution device.

### BACKGROUND

### Technical Field

Embodiments of the invention relate to the field of fiber mats, in particular natural fiber mats, such as straw or coconut fiber mats, which are used for example for the defense of erosion phenomena or for the defense of slope failures.

### Description of the Related Art

The term fiber mat is to be understood to mean a flat structural member, a few millimeters or centimeters thick, which has a width of several meters, for example of up to 6 m or of up to 8 m, and which has a length which can correspond to a multiple of the width. Owing to the length, fiber mats can be provided on rolls for transport and for processing.

Fiber mats are produced with a fiber material which corresponds for example to straw-, coconut-, compost-, xylite fibers or fiber mixtures. Such fiber mats are produced from the fiber material, by the latter being firstly compacted or pressed. The fiber mat usually additionally comprises a carrier fabric onto which the compacted or pressed fiber material is applied. Preferably, the fiber material is connected to the carrier fabric for example by a quilting method.

Fiber mats are able to be used in a variety of ways, in particular within an erosion protection, and serve for example for the securing or respectively strengthening of embankments. For this, the fiber materials are secured at the place of use, namely for instance an embankment, for example with ground anchors, wherein it is also possible to only lay out the fiber mats. Furthermore, fiber mats can also be thus used in hydraulic engineering for reinforcing banks or beds of bodies of water. In addition to the field of application on embankments and bodies of water within erosion protection, the fiber mats can also be used for the retention of sediments. In precipitations, only water is to be let through by the fiber mats, so that no sediments arrive into watercourses or respectively waste water channels.

As a whole, the field of application of fiber mats is very comprehensive, so that they must be available for the corresponding applications in various sizes, for example with widths of less than or approximately 1 m up to widths with several meters, for instance 6 m or 8 m and thicknesses of a few millimeters up to a few centimeters.

According to the prior art for the production of fiber mats, such as for example straw fiber mats, coconut fiber mats, wood fiber mats or hemp fiber mats, the corresponding fiber material of straw, coconut, wood or hemp is firstly provided in the form of fibers and is delivered to a compacting device. The compacting device is, for example, a rolling device. After or during the compacting or pressing with the compacting device, the fiber material is laid onto a carrier fabric. This takes place for example with or in a so-called non-woven fabric laying device. The non-woven fabric laying device can comprise the compacting device or can correspond to the compacting device. The carrier fabric consists for example of a plastic, such as polypropylene, a textile material or natural fibers, such as jute or coconut fibers.

In the next step, carrier fabric and fibers are connected, if this is necessary, and the thus finished fiber mat, which can also be designated as a non-woven fabric mat, is wound on rolls in its length. In the instance where a roll reaches its desired fill measurement, the fiber mat is cut along its width and the next roll is wound. A non-woven fabric laying device thus produces endless fiber mats, viewed lengthwise, with continuous material inflow.

Various devices for the automated or respectively semi-automated production of fiber mats are indeed already known, wherein these have the disadvantage, however, that despite the use of the device a partly unsatisfactory variation of the density or of the thickness of the fiber material occurs, viewed over the width and length of the fiber mat.

A reason for the variation in density or thickness is that, viewed over the width, differently pre-compacted fiber material or different quantities of fiber material are provided to the compacting device, which corresponds for example to a rolling device or comprises the latter. A problem in the variation of density or thickness is that the fiber mats partly tear or at least allow sediments through, contrary to their task. In addition, such irregular fiber mats are rolled poorly and require a greater volume on a roll, in particular through partial thickenings with comparatively identical length to uniform fiber mats.

### BRIEF SUMMARY

Some embodiments provide a device and a method for the production of fiber mats in which as constant a thickness and compacting of the fiber mat as possible can be achieved.

Some embodiments provide a fiber distribution device for the provision of fiber material for a compacting device. The fiber material corresponds for example to straw fibers, coconut fibers, wood fibers or hemp fibers. The fiber distribution device comprises a distributor box and a distribution arrangement.

The distributor box has an interior. The interior serves preferably for the provision of the fiber material for a compacting device. In addition, the distributor box comprises a dispensing opening for the dispensing of the fiber material on an underside of the distributor box, wherein the dispensing opening preferably serves to feed the fiber material to the compacting device from the interior or to provide it for the compacting device for removal from the interior. Preferably, the dispensing opening runs over an entire width or at least over a majority of the width of the distributor box. The distributor box is accordingly adapted in its width to the compacting device or the distributor box and compacting device are coordinated with one another with respect to their width.

In the instance where the compacting device consists of a rolling device for compacting the fiber material, such a rolling device comprises at least one roller, which has a length, wherein the length of the roller corresponds substantially to the width of the dispensing opening, in order to be able to provide fiber material from the interior over the entire length of the compacting device.

In addition, the distributor box has a connecting opening on the upper side. The connecting opening on the upper side is formed for example by a frame which runs along all the side walls of the distributor box. The distributor box is accordingly for example simply open upwards and offers means in the margin region for connecting with the distribution device, in order to form the connecting opening on the upper side. According to an alternative, the distributor box is partially closed on its upper side by one or more cover surfaces and has the connecting opening on the upper side in a central region.

Corresponding to the distributor box, the distribution arrangement has a distribution arrangement housing with a connecting opening on the underside. The underside connecting opening of the distribution arrangement housing is entirely or partly connected to the upperside connecting opening of the distributor box. The distribution arrangement housing is accordingly for example simply open downwards and offers in the margin region means for connecting with the distributor box, namely preferably means for connecting to the upperside connecting opening of the distributor box.

In addition, the distribution arrangement comprises an inlet opening for feeding the fiber material. Furthermore, the distribution arrangement has a tube portion which serves to feed the fiber material from an exterior of the distribution arrangement into the distribution arrangement housing and/or into the interior of the distributor box preferably through the connecting openings. The tube portion runs accordingly from the exterior of the distribution arrangement into the distribution arrangement through the inlet opening. According to an alternative, the tube portion runs from the exterior of the distribution arrangement into the distribution arrangement and further through the connecting opening into the interior of the distributor box.

The tube portion further comprises a stationary part which serves for connecting to a pipeline guiding the fiber material. The tube portion further comprises a movable part which serves for the delivery of the fiber material into the interior. In addition, the distribution arrangement comprises a motor which is connected to the movable part and is arranged to move the movable part within the distribution arrangement housing of the distribution arrangement and/or within the interior of the distributor box.

Some embodiments are based on the knowledge that in conventional known fiber distribution devices the fiber material is blown via an inlet opening directly into a distributor box. Thereby, accumulations of the fiber material occur in the interior of the distributor box in the region beneath the inlet opening, which lead to a comparatively more intensive compacting of the fiber material in this region than in other regions. The irregular distribution and the unequal compacting of the fiber material leads to a differing quantity of fiber material being removed from a compacting device with its rollers, for example outfeed rollers, from the compacting device, whereby the variation of the density or of the thickness of a manufactured fiber mat results.

Some embodiments now propose moving by a motor in a controlled manner a pipe portion which serves for feeding the fiber material, in order to thus distribute the fiber material in a controlled manner in the interior of the distributor box. A uniform distribution of the material and thus a uniform compacting in the base region of the distributor box is thus made possible. Over the entire width of the interior of the distributor box an identical quantity of material of the fiber material can thus be held and provided for the compacting device. This results in a uniform drawing in of the fiber material by rollers of the compacting device, which can also be designated as outfeed rollers, so that a uniform thickness and density of a fiber mat results therefrom.

According to a first embodiment, the stationary part of the tube portion corresponds to a first tube portion segment which is securely connected to the distribution arrangement in the region of the inlet opening. The movable part of the tube portion corresponds to a second tube portion segment. The second tube portion segment is rotatably connected at a first end on the distributor box housing in the region of the inlet opening and a second end of the second tube portion segment is arranged to deliver the fiber material into the distribution arrangement housing or into the interior of the distributor box.

Accordingly, the tube portion comprises two segments, wherein the first tube portion segment is stationary and thus serves for the connection of a stationary feed line for feeding the fiber material. The second tube portion segment then forms the movable part for delivering the fiber material. The two tube portion segments preferably have a transition region for directing the fiber material, wherein the transition region is preferably configured so that no fiber material exits. Preferably, the tube portion segments partially intersect one another or are sealed with respect to one another. Particularly preferably, for this the first tube portion segment runs partially within the second tube portion segment. This first tube portion segment thus extends preferably partially into the second tube portion segment. The entire tube portion runs in any case through the inlet opening.

By the division of the tube portion into two, it is made possible that a movement of the stationary part of the tube portion is not transferred to a connected feed line or pipeline for feeding the fiber material. The feed line can thus be configured in a rigid manner.

According to a further embodiment, the tube portion or at least the second tube portion segment runs from the first end to the second end at an angle which lies in the range of 70° to 110°. Preferably, the tube portion or at least the second tube portion segment runs at an angle which lies in the range of 80° to 90°. Particularly preferably, the angle amounts to substantially 90°. The course corresponds to a conveying direction of the fiber material through the tube portion or the second tube portion segment.

By the course of the tube portion or of the second tube portion segment at an angle and in particular of a straight course of the first tube portion segment, it is made possible to produce a rotatable connection between the second tube portion segment and the distribution arrangement housing by bearings. A rotational movement of the first end can thus be easily transferred into an oscillating movement of the second end, wherein the rotational movement is able to be realized more easily with the motor than a direct oscillating movement.

According to a further embodiment, the interior of the distributor box comprises a width, a depth and a height. The width corresponds to at least 6 times or at least 8 times the depth. The motor is connected to the tube portion in such a way so that at least the second end of the movable part is movable by the motor in a direction which runs along the width or parallel to the course of the width.

A distribution of the fiber material over the greater width of the interior compared to the depth is thus uniformly possible.

According to a further embodiment, the tube portion, in particular the second tube portion segment, is formed in a rigid manner. The tube portion or at least the second tube portion segment is accordingly preferably formed from iron, steel, aluminum or an alloy therewith.

Independently of an air pressure of the fiber material, by which an uncontrollable bending of the tube portion would occur in the case of a flexible tube portion, through the rigid construction, a defined movement of the tube portion with the motor can be achieved. A defined direction of the delivery of the fiber material can thus be achieved, in order to enable a controlled distribution of the fiber material.

According to a further embodiment, the distribution arrangement housing comprises the upper side and a frame on the underside, which forms at least partially the underside connecting opening. At least two side walls run between the frame of the underside connecting opening and the upper side. One of these side walls comprises the inlet opening. By providing the inlet opening on one of the side walls, a reduction of the overall height of the fiber distribution device is possible compared to an upperside inlet opening. The tube portion makes it possible, despite the laterally introduced fiber material, that the fiber material is not conveyed against a side wall of the distribution arrangement housing or of the distributor box, but rather in the direction of the base of the distributor box.

The height of the interior of the distributor box preferably comprises a height of several meters, for example at least 3 m, at least 4 m or at least 5 m, in order to make possible sufficient fiber material for a continuous feeding of the fiber material to or for a continuous extraction of the fiber material through a compacting device. Through the lateral inlet opening, a further increase, compared to the height of the distributor box, through a feed line for the fiber material is prevented. Manufacturing buildings can accordingly have a smaller height.

According to a further embodiment, the motor is arranged to move the first end of the second tube portion segment to and fro with respect to the distribution arrangement housing in a predefined rotation angle range. The rotation angle range preferably corresponds to a range which lies between 150° and 30° or which particularly preferably lies in a range between 60° and 120°. The midpoint of the range preferably corresponds to a vertical which, with construction of the fiber distribution device as intended, runs perpendicularly through the interior, therefore along the height, of the distributor box. By a to-and-fro movement, which can also be designated as a pivoting movement or oscillating movement, the first end of the second tube portion segment, in particular of a tube portion running in an arc, is rotated to and fro, whereby the second end of the second tube portion segment, which delivers the fiber material, is moved to and fro in a pendular manner. A uniform distribution of the fiber material is thus made possible.

According to a further embodiment, the motor is arranged to carry out a continuous rotational movement, therefore a continuous rotation clockwise or anti-clockwise. Furthermore, the motor is connected via a mechanism, in particular a linkage, to the first end of the second tube portion segment, in order to enable the continuous rotational movement into an oscillating movement of the second end, therefore a movement to and fro in the rotation angle range. A simple actuation of the motor for generating an oscillating movement is thus possible.

According to a further embodiment, the fiber distribution device comprises a control. The control is arranged to control the speed of the rotational movement of the motor. The control is arranged here in particular to adapt the speed of the rotational movement to a volume flow of the fiber material, therefore to adjust the speed as a function of the volume flow of the fiber material.

An improved control of the distribution of the fiber material is thus made possible.

According to a further embodiment, the distributor box or the distribution arrangement housing comprises at least one return opening, via which air is able to be drawn off from the interior of the distributor box. By the return opening, an excess pressure in the distributor box, which arises through fiber material delivered via air pressure, is prevented, and a controlled discharging of dust-containing air can be achieved.

In addition, some embodiments comprise a system with the fiber distribution device according to one of the embodiments and a feed line for feeding the fiber material. The feed line is preferably a pipeline and can be either as a flexible pipeline of a plastic material or a rigid feed line of a metal.

According to an embodiment of the system, the system comprises a fan by which the fiber material can be blown via the feed line into the fiber distribution device.

According to a further embodiment of the system, the system comprises a bale opener, by which the fiber material which is delivered in compressed bale form can be loosened in order to introduce the loosened fiber material by the fan into the fiber distribution device via the feed line.

According to a further embodiment, the system comprises outfeed rollers, which are arranged in the region of the delivery opening of the fiber distribution device and can also be designated as a compacting device for compacting or compressing the fiber material.

In addition, some embodiments comprise a method for operating the fiber distribution device according to one of the mentioned embodiments or for operating a system according to one of the embodiments.

### BRIEF DESCRIPTION OF THE SEVERAL VIEWS OF THE DRAWINGS

Further embodiments will emerge with the aid of the example embodiments which are shown in the figures.

FIG. 1 shows a system with a fiber distribution device.

FIG. 2 shows a distribution arrangement in perspective view.

FIG. 3 shows a distribution arrangement in a rear view.

FIG. 4 shows a section through the distribution arrangement in FIG. 3.

FIG. 5 shows an upper side of a distribution arrangement.

### DETAILED DESCRIPTION

FIG. 1 shows a system 10 with a fiber distribution device 12. The fiber distribution device 12 comprises a distributor box 14 and a distribution arrangement 16. In addition, the system 10 comprises a compacting device 18. The distributor box 14 comprises a height 20 and a width 22. The distributor box 14 has furthermore an interior 24. The interior 24 is visible through viewing openings 26, which are formed for example from plexiglass panes in side walls 28 of the distributor box 14.

The distributor box 14 has on its underside a delivery opening 30. The delivery opening 30 enables a delivery of fiber material, which is able to be provided in the distributor box, to the compacting device 18. The delivery opening 30 has a width 32 which corresponds substantially to a width 33 of the compacting device 18. The width 33 of the compacting device corresponds furthermore substantially to a length of outfeed rollers of the compacting device 18. Fiber mats can thus be produced with the width 32 of the compacting device 18.

In addition, the distribution arrangement comprises a distribution arrangement housing 34 with a connecting opening 36 on the underside, which is connected to a connecting opening 38 of the distributor box 14 on the upper side. In addition, the distribution arrangement housing 34 comprises an upper side 40 and a side wall 42 which is visible here. An inlet opening 44 is provided in the side wall 42. Fiber material can be fed via the inlet opening 44 by a feed line which is connected to the inlet opening 44. Furthermore, the fiber distribution device 12 comprises a motor 46, which is arranged to move a tube portion 52, running through the inlet opening 44, in a rotation angle range 54, by means of a mechanism 48 which is formed as a linkage 50.

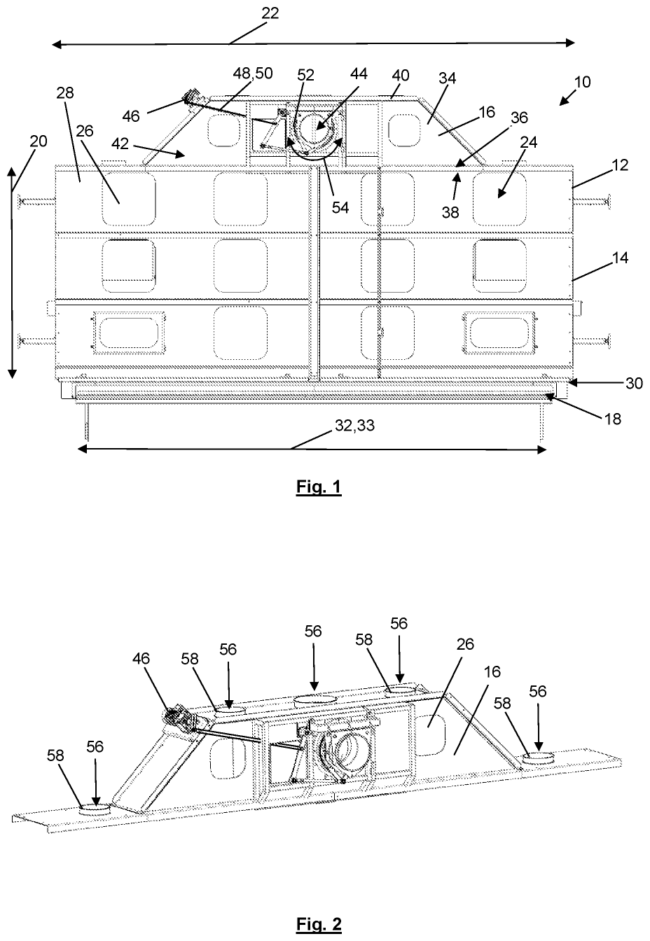

FIG. 2 shows a perspective view of the distribution arrangement 16. The distribution arrangement 16 also has viewing openings 26, which are of plexiglass for example, in order to view into an inner region of the distribution arrangement housing 34, for example in order to check a height of the fiber material. In addition, return openings 56 can be seen, for the drawing of air out from the fiber distribution device 12. Depending on the required overall height or function, the return openings 56 can opened for use in the central region or externally, or closed by covers 58. In the present example embodiment, a central return opening 56 is provided, which is not covered.

According to further example embodiments, which deviate from the figures, fewer than the illustrated return openings 56 are provided, namely only one or two of the return openings 56. Otherwise, however, the further example embodiments which are designated here with few return openings have all the features of the figures.

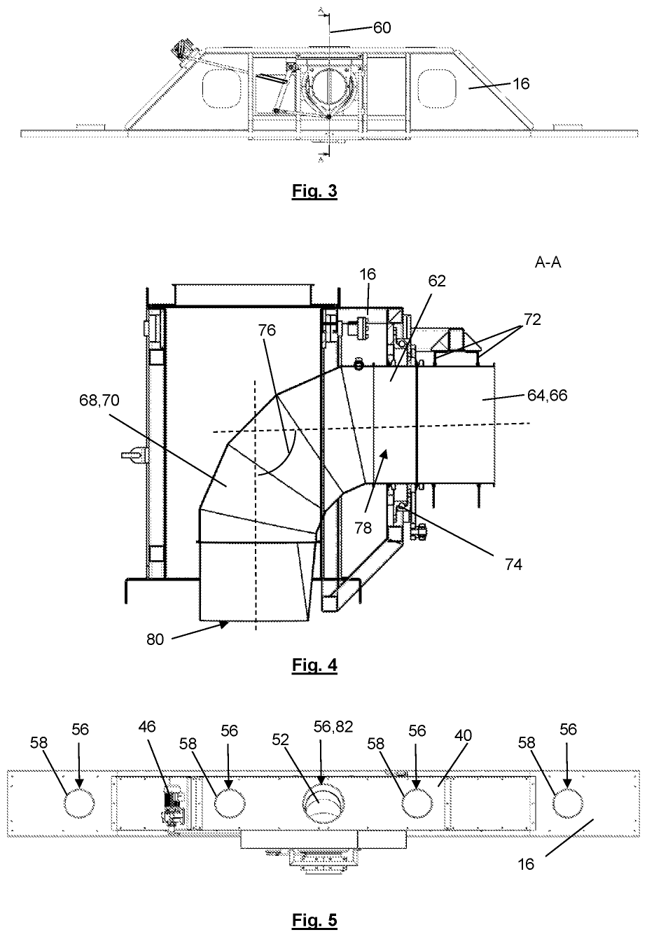

FIG. 3 shows a further view of the distribution arrangement 16, wherein a section plane 60 is illustrated. A sectional view, corresponding to the section plane 60, is illustrated in FIG. 4.

In FIG. 4 a tube portion 62 is illustrated in the section plane 60. The tube portion 62 has a stationary part 64, which can also be designated as first tube portion segment 66. In addition, a movable part 68 of the tube portion 62 is illustrated, which can also be designated as second tube portion segment 70. The first tube portion segment 66 is securely connected to the distribution arrangement via rigid connections 72. The second tube portion segment 70 is arranged mounted rotatably via bearings 74 on the distribution arrangement 16. The second tube portion segment runs at an angle 76 of 90°. Accordingly, a first end 78 of the second tube portion segment 70 is rotatably mounted, and a second end 80 is pivotable in the direction of the width 22 of the interior 24.

FIG. 5 shows a view onto the upper side 40 of the distribution arrangement 16, wherein again the covered return openings 56 and a central open return opening 82 are illustrated. Through the open return opening 82 the tube portion 52 can be seen, which is situated in its central position. Furthermore, the motor 46 can also be seen.

### LIST OF REFERENCE NUMBERS

10 system
12 fiber distribution device
14 distributor box
16 distribution arrangement
18 compacting device
20 height
22 width
24 interior
26 viewing openings
28 side walls
30 delivery opening
32 width
33 width
34 distribution arrangement housing
36 connecting opening on the underside
38 connecting opening on the upper side
40 upper side
42 side wall
44 inlet opening
46 motor
48 mechanism
50 linkage
52 tube portion
54 rotation angle range
56 return opening
58 cover
60 section plane
62 tube portion
64 stationary part
66 first tube portion segment
68 movable part
70 second tube portion segment
72 rigid connection
74 bearing
76 angle
78 first end
80 second end
82 open return opening

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A fiber distribution device for providing fiber material, such as straw fibers, coconut fibers, wood fibers or hemp fibers for a compacting device, comprising:
a distributor box, wherein the distributor box has an interior with a connecting opening on the upper side, and with a delivery opening on the underside for delivery of the fiber material, and
a distribution arrangement with a distribution arrangement housing, which has a connecting opening on the underside for connecting to the connecting opening of the distributor box on the upper side, and an inlet opening for feeding the fiber material, wherein the distribution arrangement has:
a tube portion for feeding the fiber material from an exterior of the distribution arrangement into the interior of the distributor box or into the distribution arrangement housing, wherein the tube portion has a fixed part for connecting to a feed line guiding the fiber material, and a movable part for delivering the fiber material, and
a motor which is connected to the movable part and is arranged to move the movable part in the distribution arrangement and/or in the interior of the distributor box.

2. The fiber distribution device according to claim 1, wherein the stationary part of the tube portion corresponds to a first tube portion segment, which is securely connected to the distribution arrangement in the region of the inlet opening, and the movable part of the tube portion corresponds to a second tube portion segment, which at a first end is rotatably connected to the distribution arrangement housing in the region of the inlet opening, and which at a second end is arranged to deliver the fiber material into the distributor box.

3. The fiber distribution device according to claim 1, wherein the movable part, namely the second tube portion segment, runs at an angle in the range of 70° to 110° from the first end to the second end.

4. The fiber distribution device according to claim 3, wherein the movable part, namely the second tube portion segment, runs at an angle in the range of 80° to 100° from the first end to the second end.

5. The fiber distribution device according to claim 3, wherein the movable part, namely the second tube portion segment, runs at an angle of 90° from the first end to the second end.

6. The fiber distribution device according to claim 1, wherein the interior has a width, a depth and a height, wherein the width corresponds to at least 6 times the depth, and the motor is connected to the tube portion in such a way in order to move at least the second end of the movable part in a direction of the width or a direction which runs in the direction of the width.

7. The fiber distribution device according to claim 1, wherein the interior has a width, a depth and a height, wherein the width corresponds to at least 8 times the depth, and the motor is connected to the tube portion in such a way in order to move at least the second end of the movable part in a direction of the width or a direction which runs in the direction of the width.

8. The fiber distribution device according to claim 1, wherein the stationary part and the movable part of the tube portion are formed in a rigid manner from iron, steel, aluminum or an alloy therewith.

9. The fiber distribution device according to claim 1, wherein the distribution arrangement housing has a frame forming the connecting opening on the underside, an upper side and at least two side walls running between the frame and the upper side, wherein the inlet opening is arranged in one of the side walls.

10. The fiber distribution device according to claim 1, wherein the motor is arranged to rotate the first end of the second tube portion segment to and fro with respect to the distribution arrangement housing in a predefined rotation angle, wherein the rotation angle range corresponds to a range between 150° and 30°.

11. The fiber distribution device of claim 10, wherein the rotation angle range correspondence to a range between 60° and 120°.

12. The fiber distribution device according to claim 1, wherein the motor is arranged to carry out a continuous rotational movement and is connected via a mechanism, the mechanism including a linkage, to the first end of the second tube portion segment, in order to transfer the continuous rotational movement into an oscillating movement, therefore a moving to and fro, of the second end.

13. The fiber distribution device according to claim 1, wherein the fiber distribution device has a control, and the control is arranged to control the speed of the rotational movement of the motor and to adapt or adjust the rotational speed as a function of the volume flow.

14. The fiber distribution device according to claim 1, wherein the distributor box or the distribution arrangement housing has at least one return opening, via which air is able to be drawn off from the interior of the distributor box.

15. A system comprising a fiber distribution device according to claim 1 and a feed line for feeding fiber material.

16. The system according to claim 15, further comprising a fan which is connected to the feed line in order to blow fiber material via the feed line into the fiber distribution device.

17. The system according to claim 14, wherein the system comprises a bale opener, in order to loosen a bale of compacted fiber material and to feed it to the fan.

18. The system according to claim 15, wherein the system comprises a compacting device, the compacting device comprising at least one roller, wherein the roller is arranged in the region of a delivery opening of the fiber distribution device and runs at least over the majority of the width of the distributor box of the fiber distribution device with its length.

19. A method for providing fiber material for a compacting device with a fiber distribution device according to claim 1, wherein the method comprises operating the fiber distribution device.
